(19) United States
(12) Patent Application Publication
(10) Pub. No.: US 2013/0100697 A1
(43) Pub. Date: Apr. 25, 2013

(54) BACKLIGHT MODULE

(71) Applicants: TAI-CHERNG YU, Tu-Cheng (TW); DA-WEI LIN, Tu-Cheng (TW)

(72) Inventors: TAI-CHERNG YU, Tu-Cheng (TW); DA-WEI LIN, Tu-Cheng (TW)

(73) Assignee: HON HAI PRECISION INDUSTRY CO., LTD., Tu-Cheng (TW)

(21) Appl. No.: 13/430,695

(22) Filed: Mar. 27, 2012

(30) Foreign Application Priority Data
Oct. 24, 2011 (TW) 100138430

(51) Int. Cl. F21V 9/16

(52) U.S. Cl. 362/608

(57) ABSTRACT

A backlight module includes a light source assembly, a light guiding plate, an optical clear adhesive, and a light diffusion member. The diffusion member is positioned on the light guiding plate via the optical clear adhesive. The diffusion member includes yellow phosphor powders. The light source assembly includes a substrate and a number of point light sources arrayed on the substrate. The point light sources are blue light emitting diodes. The point light sources are aligned with the light diffusion member.

### BACKGROUND

1. Technical Field

The present disclosure relates to a backlight module.

2. Description of Related Art

Liquid crystal display (LCD) devices have many excellent performance characteristics, such as large-scale information display ability, easy colorization, low power consumption, long lifespan, and as well as being environmentally friendly, for example. Therefore, LCD devices are widely used. A typical LCD device generally includes a backlight module. The backlight module is used to convert linear light sources or light source assemblies, such as cold cathode ray tubes or light emitting diodes (LEDs), into area light sources with high uniformity and brightness.

When only one LED is employed by the LCD device as the light source, the LED emits the light at a certain range of angle, and generally cannot cover the whole light guiding plate. Thus, the backlight module can have non-uniform illumination. Accordingly, a number of LEDs are employed. However, a number of dark regions tend to be formed in areas of the light guide plate, between every two adjacent LEDs.

Therefore, it is desirable to provide a backlight module, which can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an exploded, isometric view of a backlight module which includes a light guiding plate, a optical clear adhesive and a light diffusion member, according to a first embodiment.

FIG. 2 is an assembled, isometric view of the light guiding plate, the optical clear adhesive and the light diffusion member of FIG. 1, viewed from another angle.

FIG. 3 is an exploded, isometric view of a backlight module, according to a second embodiment.

### DETAILED DESCRIPTION

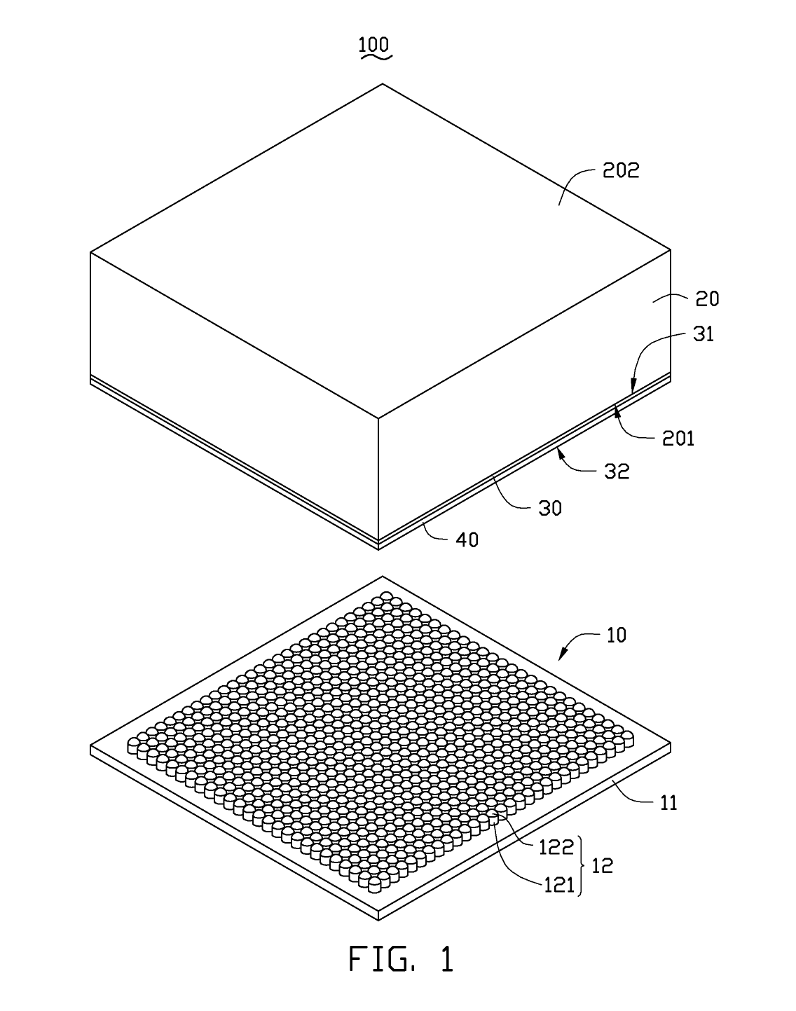

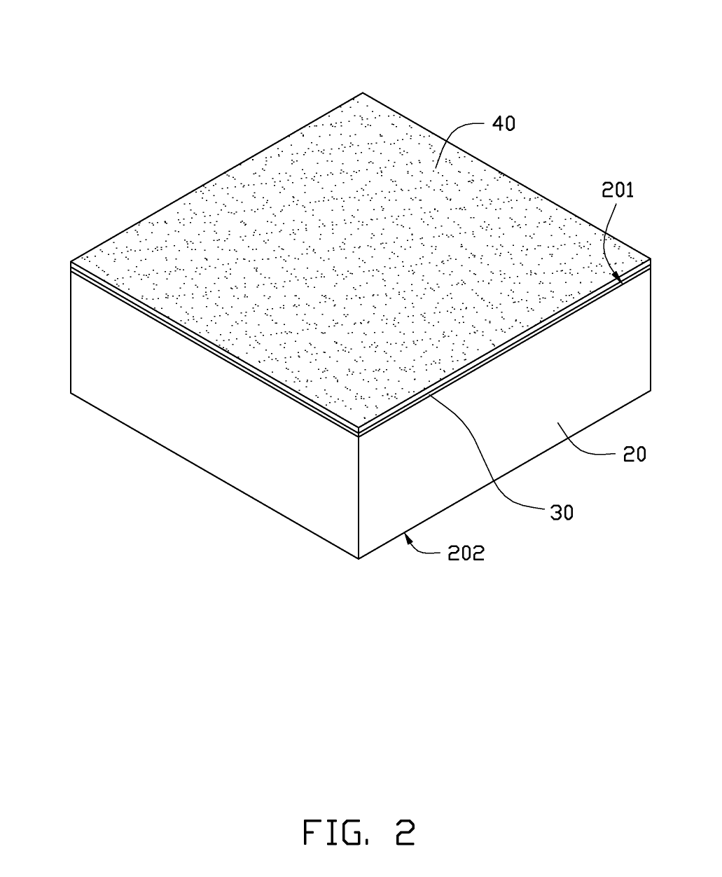

FIGS. 1-2, show a backlight module 100 for a display, according to a first embodiment. The backlight module 100 includes a light source assembly 10, a light guiding plate 20, an optical clear adhesive (OCA) 30, and a light diffusion member 40. The diffusion member 40 is positioned on the light guiding plate 20 via the OCA 30. The light source assembly 10 is aligned with the light diffusion member 40.

The light source assembly 10 includes a substrate 11 and a number of point light sources 12. The substrate 11 is rectangular in shape. The number of point light sources 12 are blue light emitting diodes (LEDs) and are orthogonally arrayed on the substrate 11. Each point light source 12 includes an electrical connection portion 121 positioned on the substrate 11, and a light-emitting portion 122 mounted on the electrical connection portion 121. In the embodiment, each two adjacent point sources 12 are closely contacted with each other.

The light guiding plate 20 includes a light incident surface 201 facing the substrate 11, and a light emitting surface 202 facing away from the substrate 11. In the embodiment, the light source assembly 10 is aligned with the light incident surface 201, and the point light sources 12 are arranged in a plane parallel to the light incident surface 201. The light incident surface 201 faces away from and is parallel to the light emitting surface 202. The shapes of the light incident surface 201 and the light emitting surface 202 correspond to that of the substrate 11. In the embodiment, the light incident surface 201 and the light emitting surface 202 is also rectangular in shape, the sizes of the light incident surface 201 and the light emitting surface 202 are equal to or smaller than that of the substrate 11.

In the embodiment, the OCA 30 is a double sided adhesive layer and includes two opposite surfaces: a first surface 31 and a second surface 32. The first surface 31 is positioned on the light incident surface 201 of the light guiding plate 20. The second surface 32 faces the light source assembly 10.

In the embodiment, the light diffusion member 40 is a phosphor plate with yellow phosphor powder made by a remote phosphor technology. The light diffusion member 40 is positioned on the second surface 32 of the OCA 30. The material of the yellow phosphor powder includes Y₃Al₅O₁₂:Ce³⁺ (cerium-doped yttrium aluminum garnet).

In an alternative embodiment, the light diffusion member 40 can be yellow phosphor powder, which is evenly sprinkled on the second surface 32 of the OCA 30.

In operation, blue light emitted from the point light sources 12 enters the light diffusion member 40 and stimulates yellow phosphor powder of the light diffusion member 40 to emit yellow light mixed with the blue light emitted by the point light sources 12 to form white light. The white light enters into the light guiding plate 20 through the light incident surface 201 and then exits from the light emitting surface 202 of the light guiding plate 20 uniformly. Additionally, the light diffusion member 40 can diffuse the white light and enlarge the field of illumination of the white light.

Unlike a conventional backlight module, the light diffusion member 40 of the backlight module 100 of the present embodiment converts point light emitted by the point light sources 12 into surface light source, which improves the uniformly of the illumination. In addition, the light diffusion member 40 is closely positioned on the light incident surface 201 of the light guiding plate 20 via the OCA 30, the light emitted by the point light sources 12 can be directly coupled into the light guiding plate 20 without the loss of the air interface reflection and scattering of light.

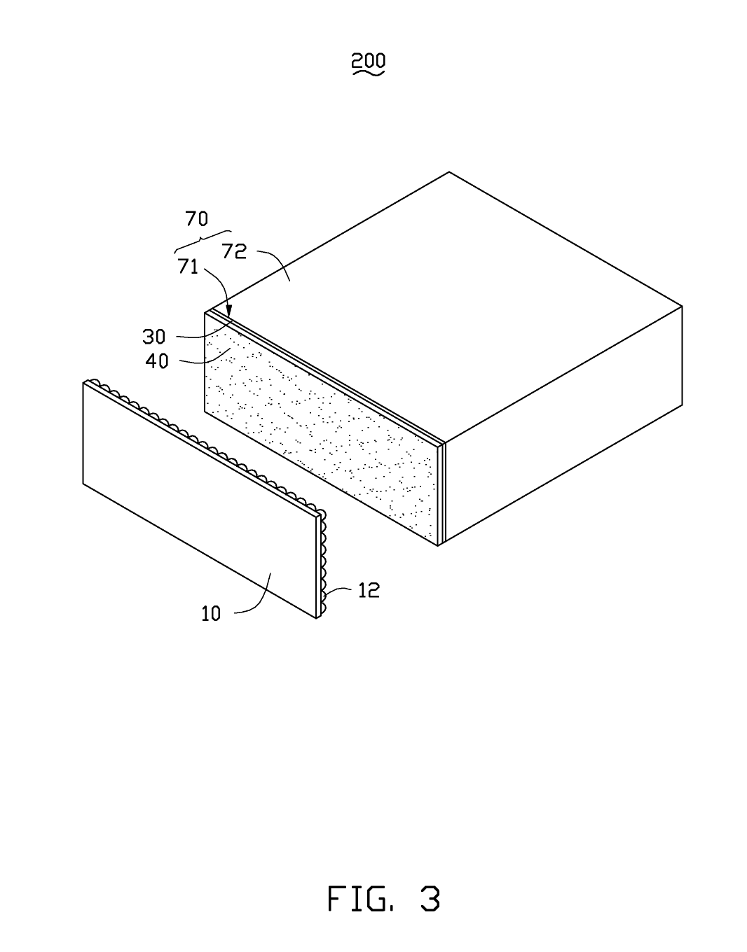

Referring to FIG. 3, a backlight module 200, in accordance with a second exemplary embodiment. The backlight module 200 is essentially similar to the backlight module 100 in the first embodiment, except that the backlight module 200 includes a light guiding plate 70, and the light guiding plate 70 includes a light incident surface 71 and a light emitting surface 72 perpendicularly connected to the light incident surface 71. The OCA 30 is positioned on the light incident surface 71 and wholly covers the light incident surface 71. The light diffusion member 40 is positioned on the OCA 30. The light source assembly 10 is aligned with the light incident surface 71. The point light sources 12 of the light source assembly 10 are arranged in a plane parallel with the light incident surface 71. In other embodiments, the light diffusion member 40 can be yellow phosphor powders which are evenly sprinkled on a surface of the OCA 30 facing the light source assembly 10.

Unlike a conventional backlight module, the light source assembly 10 of the backlight module 200 of the present embodiment is arranged in a plane parallel with the light incident surface 71, which can reduce the height of the backlight module 200.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A backlight module comprising:
a light guiding plate comprising a light incident surface;
an optical clear adhesive optically aligned with the light incident surface;
a diffusion member positioned on the optical clear adhesive, the diffusion member comprising yellow phosphor powder; and
a light source assembly comprising a substrate and a plurality of point light sources arrayed on the substrate, the plurality of point light sources being blue light emitting diodes, the point light sources optically aligned with the light diffusion member.

2. The backlight module of claim 1, wherein the light guiding plate comprises a light emitting surface for emitting light from the light source assembly.

3. The backlight module of claim 2, wherein the light incident surface is parallel to and faces away from the light emitting surface, the point light sources are arranged in a plane parallel with the light incident surface, a surface of the optical clear adhesive is positioned on the light incident surface, the diffusion member is positioned on another opposite surface of the optical clear adhesive.

4. The backlight module of claim 3, wherein the shape of the light incident surface corresponds to the shape of the substrate.

5. The backlight module of claim 3, wherein the size of the light incident surface is equal to or smaller than the shape of the substrate.

6. The backlight module of claim 2, wherein the light incident surface is perpendicularly connected to the light emitting surface, the point light sources are arranged in a plane parallel with the light incident surface of the light guiding plate, a surface of the optical clear adhesive is positioned on the light incident surface, the diffusion member is positioned on another opposite surface of the optical clear adhesive.

7. The backlight module of claim 1, wherein the substrate is rectangular in shape, the plurality of point light sources are orthogonally arrayed on the substrate.

8. The backlight module of claim 1, wherein the light diffusion member is a phosphor plate with yellow phosphor powders.

9. The backlight module of claim 1, wherein the light diffusion member comprises yellow phosphor powders which are evenly sprinkled on the optical clear adhesive.

10. The backlight module of claim 9, wherein the material of the yellow phosphor powders is cerium-doped yttrium aluminum garnet.

11. The backlight module of claim 1, wherein each point light source comprises an electrical connection portion positioned on the substrate, and a light-emitting portion mounted on the electrical connection portion.

12. The backlight module of claim 1, wherein each two adjacent point sources are closely contacted with each other.

13. The backlight module of claim 1, wherein the optical clear adhesive is a double sided adhesive layer.
